(19) United States
(12) Patent Application Publication
(10) Pub. No.: US 2009/0315005 A1
(43) Pub. Date: Dec. 24, 2009

(54) STAKE PULLING TOOL

(76) Inventors: Glenn Hironaga, Honolulu, HI (US); Peter Tsukamoto, Honolulu, HI (US)

Correspondence Address: ITALIA IP, 3500 WEST OLIVE AVE., SUITE 300, BURBANK, CA, 91505, US

(21) Appl. No.: 12/141,312

(22) Filed: Jun. 18, 2008

(51) Int. Cl. B66F 1/00

(52) U.S. Cl. 254/132

(57) ABSTRACT

A tool for exerting pulling forces for extracting a large headed stake which has been driven into the ground. The tool may have an elongated body bearing a handle at one end and two offset projections for abutting the large head of the stake at the other end. The projections are configured to present abutting surfaces when the tool is generally aligned parallel to the stake and also when the tool is aligned perpendicularly to the stake. The tool may be used in an impacting mode and alternatively in a prying mode. The handle can engage one end of a lever to develop increased pulling force.

### BACKGROUND OF THE INVENTION

### Field of the Invention

This application relates generally to the field of devices which are used for the removal of stakes, posts, rods, or the like which have been driven into or otherwise placed into the ground. More specifically, this application relates to a stake pulling tool.

### BACKGROUND OF THE INVENTION

In the construction industry in particular, it is frequently necessary to drive stakes into the ground to support foundation members and ancillary structures such as forms for forming foundations members from poured concrete. The stakes and posts become very difficult to remove under most circumstances since they are generally directly pressing against the foundation members or the like, and thus when it is time to remove the stakes, it is very difficult to get convenient access to exert forces for pulling the stakes from their locations.

In light of this difficulty, is has become commonplace to remove foundation stakes by either breaking them off, or by hitting them repeatedly with hammers to loosen the grip of surrounding ground, or by further driving them into the ground and leaving them to rot away over time. Such procedures increase construction costs due to additional time required, and further result in loss of the stakes, which if recovered could be utilized in subsequent construction. Therefore, this application discloses a tool that enables a user to economically and efficiently extract such stakes from the ground.

### SUMMARY OF THE INVENTION

This application discloses a tool which facilitates extraction of a stake which has been driven into the ground. The disclosed tool is economical to produce, of uncomplicated construction, and capable of mass production.

More particularly, this application discloses a stake pulling tool for pulling a stake in an upward direction relative from the ground. The tool may have at least two different and distinct engagement surfaces for engaging a large headed stake in order to impose pulling forces thereto. The disclosed tool can be operated in several ways, including in the manner of a manual slide hammer and as a manual prying tool. Even further, the several different and distinct engagement surfaces enable engagement of a driven stake in more than one position of the tool, thereby increasing tool versatility and convenience to personnel charged with removing large headed stakes. This versatility enables most stakes to be conveniently extracted without requiring specialized tools beyond that of the present application.

It is therefore an object of the invention to provide a manual stake pulling tool which can conveniently extract large headed stakes which have been driven into the ground at foundation sites.

It is another object of the invention to provide a manual stake pulling tool which can operate either in the manner of a slide hammer or alternatively as a prying tool.

A further object of the invention is to provide a manual stake pulling tool which affords at least two different orientations in engaging a large headed stake to be extracted from the ground.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a stake pulling tool according to at least one aspect of the invention.

FIG. 2 is a perspective view of the environment of the problem which is solved by the present invention.

FIG. 3 is an environmental perspective detail view showing engagement of a broad head of a stake by the tool of FIG. 1, shown with the tool spaced apart from the stake.

FIG. 4 is an end elevation of FIG. 3.

FIG. 5 is an environmental perspective detail view showing engagement of a broad head of a stake by the tool of FIG. 1, but illustrating a second orientation of the tool to the stake, shown with the tool spaced apart from the stake.

FIG. 6 is an environmental perspective view showing engagement of the tool of FIG. 1 as it may be employed as a prying tool.

FIG. 7 is an environmental perspective view showing another arrangement for using the tool of FIG. 1 as a prying tool.

### DETAILED DESCRIPTION

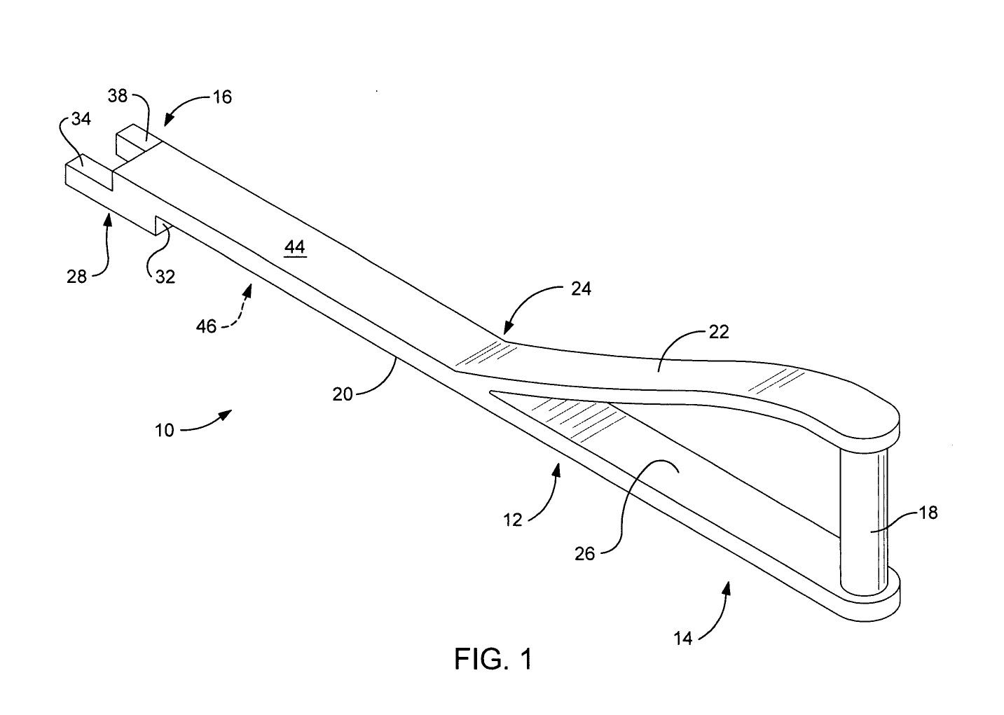

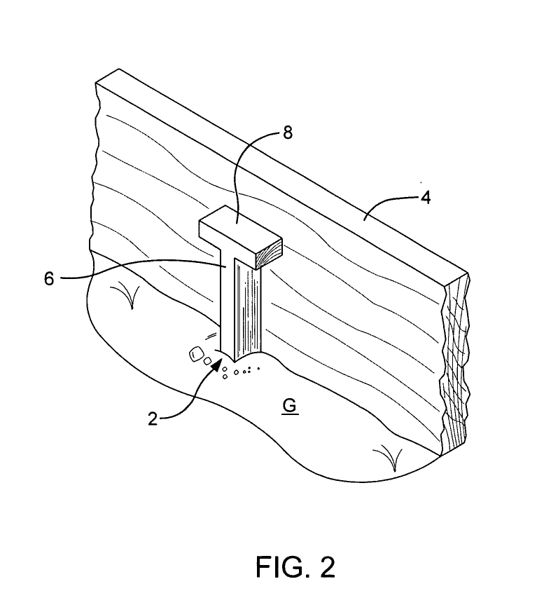

FIG. 1 of the drawings shows a stake pulling tool 10 according to at least one aspect of the invention. The tool 10 is intended for pulling a large headed stake (see FIG. 2) by the enlarged head thereof. As used herein, “stake” encompasses any like devices that can be driven into the ground, which have enlarged heads.

The tool 10 may comprise an elongated body 12 having a handle end 14 and a working end 16. A cylindrical handle 18 may be connected transversely to the elongated body 12 at the handle end 14 thereof. The handle 18 may be cylindrical along at least part of its length, whereby the handle is comfortably grasped by hand. The elongated body 12 may comprise two divergent members including a principal member 20 and a minor member 22. The minor member 22 may be fixed to the principal member 20 at a joint 24. The principal member 20 and the minor member 22 may each have respective free ends, the handle 18 spanning the free ends. The principal member 20, the minor member 22, and the handle 18 collectively form a peripherally closed passageway or opening 26, the purpose of which will be explained hereinafter.

At the working end 16, the tool 10 includes a first engagement member 28 and a second engagement member 30 fixed to the elongated body 12. As will be further explained hereinafter, the first and second engagement members 28 and 30 engage the enlarged head of the stake being pulled from the ground. As clearly seen in FIG. 1, the first engagement member 28 is generally parallel to the second engagement member 30. The first engagement member 28 may have a first contact surface 32 for engaging the stake and a second contact surface 34 for engaging the stake when positioned differently. Similarly, the second engagement member 30 may have a third contact surface 36 and a fourth contact surface 38. It will be seen that the first contact surface 32 of the first engagement member 28 and the third contact surface 36 of the second engagement member 30 face the handle 18.

The elongated body 12, the first engagement member 28, and the second engagement member 30 may be fabricated from one or more suitable sturdy materials such as steel. The handle 18 may be fabricated from for example wood, plastic, or steel.

Turning momentarily to FIG. 2, a large headed stake 2 is seen driven in close proximity to a foundation member 4. The large headed stake 2 comprises a shaft 6 and an enlarged head 8, and is driven into the ground G such that ready removal by hand is difficult if not impossible.

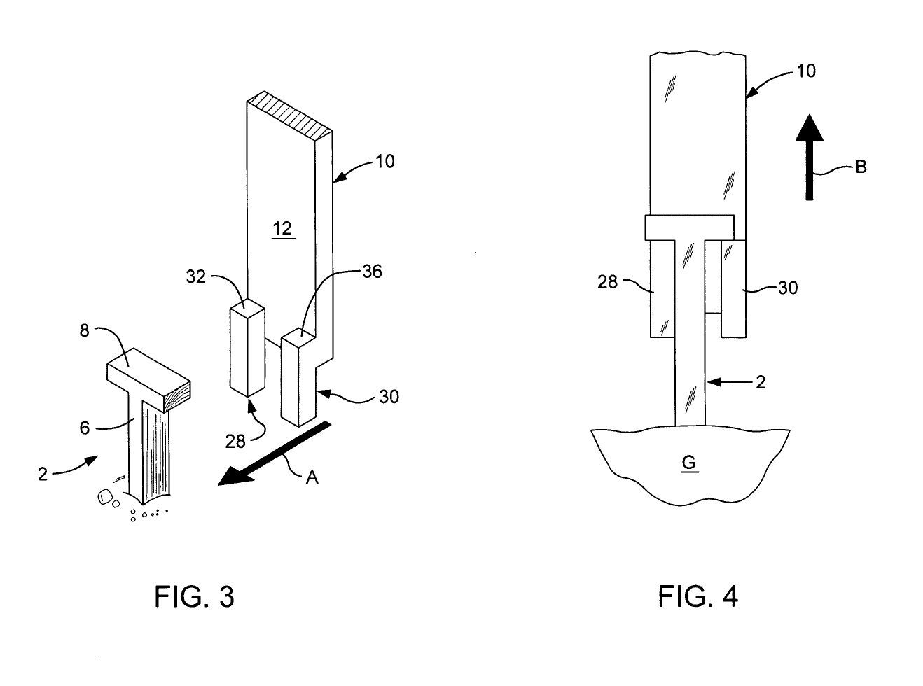

FIG. 3 shows one method of using the tool 10 (not shown in its entirety in FIG. 3). With the elongated body 12 in a substantially vertical orientation, the tool 10 is moved in the direction of the arrow A until the respective contact surfaces 32 and 36 are below the elongated head 8.

It should be noted at this point that orientational terms such as up and down, left and right, and others refer to the drawing as viewed by an observer. Terms such as vertical and horizontal are relative to the field of gravity.

With the contact surfaces 32 and 36 straddling the shaft 6, the tool 10 is then raised until the contact surfaces 32 and 36 abut the underside of the enlarged head 8. If minor upward pressure cannot dislodge the stake 2 from the ground, then the tool 10 may be accelerated while raising to the point that an impact is imposed on the enlarged head 2 when contact between the tool 10 and the enlarged head 8 occurs. Alternatively stated, with the engagement members 28 and 30 straddling or forking the shaft 6 of the stake 2, the tool 10 may be utilized in the manner of a slide hammer. FIG. 4 shows engagement of the tool 10, which is being moved upwardly in the direction of the arrow B, with the stake 2 at the moment of mutual abutment. One or more blows with the tool 10 may be required to break the stake 2 free of engagement with the ground G.

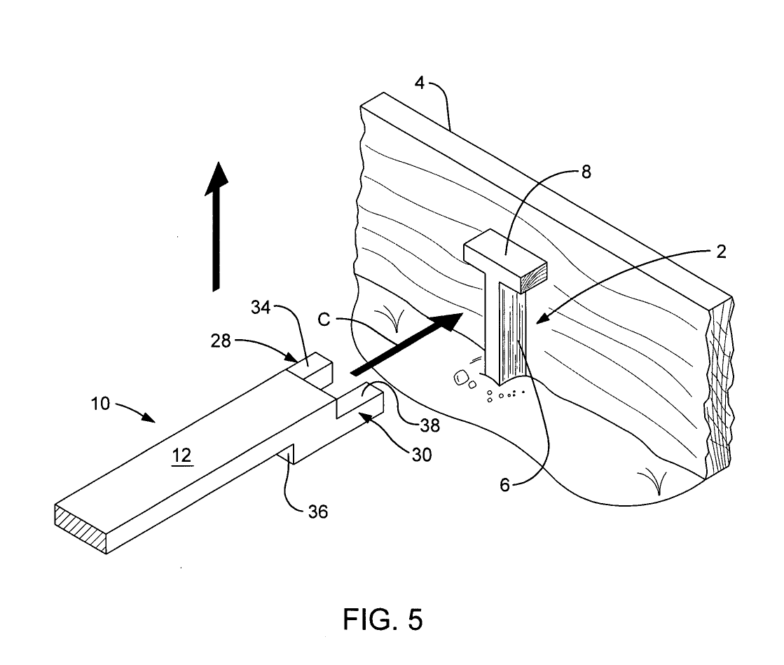

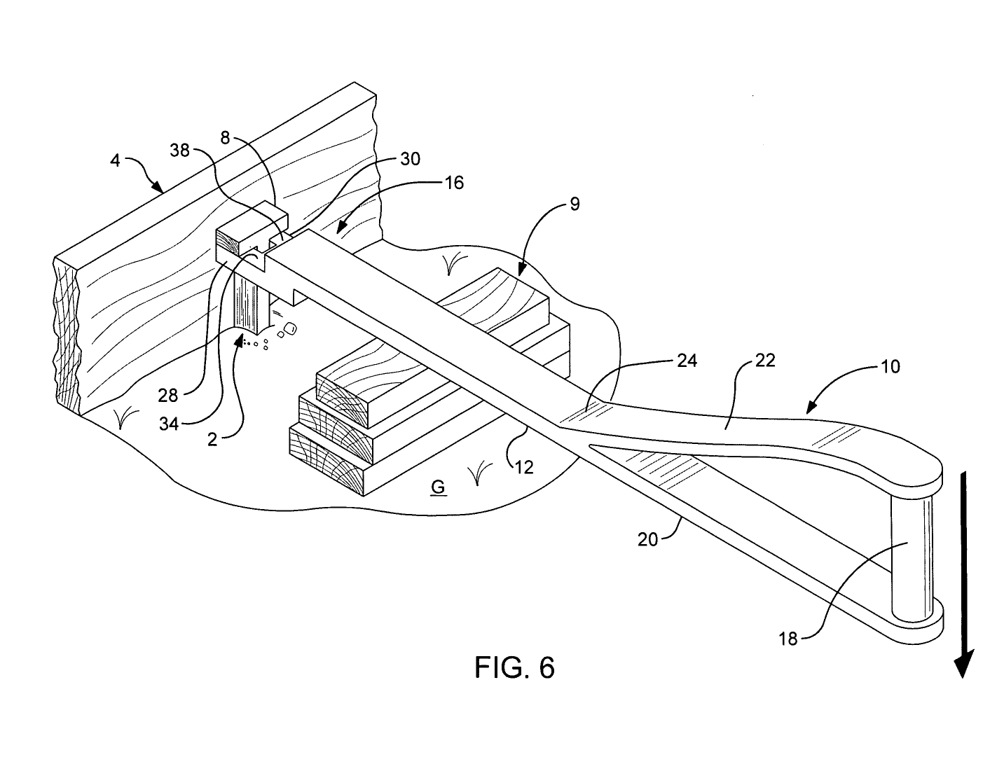

Turning now to FIG. 5, another method of using the tool 10 is shown. The tool 10, again not shown in its entirety, straddles or forks the shaft 6 of the stake 2. The tool 10 is moved in the direction of the arrow C into straddling or forked relation to the shaft 6. In the orientation of FIG. 5, contact surfaces 34 and 38 of the respective engagement members 28 and 30 are used in place of the contact surfaces 32 and 36 which were employed in the mode of use depicted in FIG. 4. Although impacts may be applied as described in the alternative orientation above, if feasible, the mode of FIG. 5 is also well suited to using the tool 10 as a pry tool. This is shown in FIG. 6, wherein the tool 10 is positioned with the elongated body 12 lying on any suitable material which can serve as a fulcrum, such as a stack 9 of lumber. When the handle end 14 of the tool 10 is moved downwardly, as indicated by the arrow D, an upwardly acting force is exerted at the working head 16. With the engagement members 28 and 30 contacting the enlarged head 8, more specifically contact surfaces 34 and 38 respectively, of the stake 2, the stake 2 is subjected to lifting forces which will extract the stake 2 from the ground G.

It will be appreciated that the geometry which enables these different modes of use may include the following characteristics. Firstly, the elongated body 12 has a length, the first engagement member 28 has a length aligned with the length of the elongated body 12, and the second engagement member 30 also has a length aligned with the length of the elongated body 12. Secondly, the first contact surface 32 of the first engagement member 28 is generally perpendicular to the second contact surface 34 of the first engagement member 28, and the third contact surface 36 of the second engagement member 30 is generally perpendicular to the fourth contact surface 38 of the second engagement member 30.

Thirdly, because the engagement members 28 and 30 may be parallel to one another, it follows that the first contact surface 32 and the third contact surface 36 may be coplanar with one another. Similarly, the second contact surface 34 and the fourth contact surface 38 may be coplanar with one another. The first contact surface 32 and the third contact surface 36 are not parallel to the second contact surface 34 and the fourth contact surface 38. Rather, the first contact surface 32 and the third contact surface 36 may be perpendicular to the second contact surface 34 and the fourth contact surface 38, as occurs with the tool 10. These relationships assure that the enlarged head 8 of the stake 2, where formed by a linear board, will be simultaneously and evenly contacted by the tool 10 during extraction.

Again referring to FIG. 1, the principal member 20 of the elongated body 12 may have a planar first flat face 44 and an opposed planar second flat face 46. Both the first contact surface 32 of the first engagement member 28 and the third contact surface 36 of the second engagement member 30 are perpendicular to the planar first flat face 44 of the elongated body 12. It will be seen that a hypothetical plane may be considered to exist parallel to and between the faces 44 and 46. This plane, which may be coincident with the first flat face 44 or with the second flat face 46 as well as being located between the these two flat faces 44 and 46, may be regarded as a dividing plane which separates the two flat faces 44 and 46.

The handle 18 and the diverging minor member 22 may be located on one side of the hypothetical dividing plane, with the engagement members 28 and 30 located on the opposite side of the hypothetical dividing plane. This arrangement assures that the elongated body 12 will be left with a straight section available for sliding contact with the large headed stake 2 when the tool 10 is used in the manner described with respect to FIGS. 3 and 4. This enables the tool 10 to be accelerated along a straight line while sliding against the large headed stake 2 so that a significant impact may be generated upon contact of the first engagement member 28 and the second engagement member 30 with the large headed stake 2.

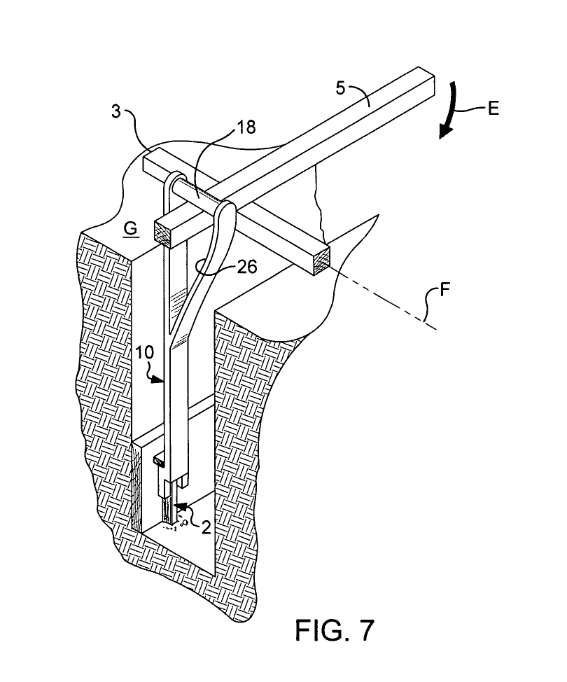

FIG. 7 depicts a further way of using the tool 10. In cases wherein the stake 2 is contained within a well, trench, or other recess such that direct access is not possible, the tool 10 may be employed as shown. The tool 10 may be placed into engagement with the enlarged head 8 of the stake 2, as was described with respect to FIGS. 3 and 4. A board 3 may be placed on the ground G such that a second board 5 may be placed as shown. The board 5 acts as a lever, using the board 3 as a fulcrum. The board 5 passes through the passageway 26 of the tool 10. When a downward force (represented as an arrow E) is imposed on one end of the board 5, an increased upwardly acting force on the other side of the axis F of pivot is imposed on the handle 18 of the tool 18. This upward force is transmitted by the tool to the stake 2, which is thereby extracted.

Other ways of utilizing a tool such as the tool 10 exist. It would be possible for example to extract stakes (not shown) which lack an enlarged head such as the enlarged head 2. Using a suitable apparatus such as a collar (not shown), which when placed over the stake and subjected to pulling forces grips the stake due to a sideward bias, may enable the tool 10 to impose pulling forces and impacts on a stake in the absence of an enlarged head.

A tool according to other aspects of the invention may display variations of and modifications to the characteristics of the tool 10 as shown and described. For example, the elongated body 12 of the tool 10 may, instead of the flattened slab-like configuration shown, be tubular, square, formed from a stock channel configured as a “U”, or otherwise configured in cross section. The diverging minor member 22 may form a mirror image with the corresponding section of the principal member 20.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

We claim:

1. A tool for pulling a large headed stake by the enlarged head of the large headed stake, comprising:
an elongated body having a handle end and a working end; and
at least a first engagement member fixed to the elongated body at the working end thereof and at least a second engagement member fixed to the elongated body at the working end thereof, for abutting the enlarged head of the large headed stake,
wherein the first engagement member has a first contact surface for abutting the enlarged head of the large headed stake and a second contact surface for abutting the enlarged head of the large headed stake, the second engagement member has a third contact surface for abutting the enlarged head of the large headed stake which is generally coplanar with the first contact surface of the first engagement member and a fourth contact surface which is generally coplanar with the second contact surface of the first engagement member, and wherein the first contact surface and the third contact surface are not parallel to the second contact surface and the fourth contact surface.

2. The tool according to claim 1, wherein the first contact surface of the first engagement member is generally perpendicular to the second contact surface of the first engagement member, and the third contact surface of the second engagement member is generally perpendicular to the fourth contact surface of the second engagement member.

3. The tool according to claim 1, further comprising a handle connected transversely to the elongated body at the handle end of the body.

4. The tool according to claim 3, wherein the elongated body comprises two divergent members each having a free end, and the handle spans the free ends of the two divergent members to define a peripherally closed passageway collectively formed by the two divergent members and the handle.

5. The tool according to claim 1, wherein the elongated body has a length, the first engagement member has a length aligned with the length of the body, and the second engagement member has a length aligned with the length of the body.

6. The tool according to claim 1, wherein the first engagement member is generally parallel to the second engagement member, and the first contact surface of the first engagement member and the third contact surface of the second engagement member face the handle.

7. The tool according to claim 1, wherein the handle is at least partially cylindrical along its length, whereby the handle is comfortably grasped by hand.

8. The tool according to claim 1, wherein the elongated body has a planar first flat face and an opposed planar second flat face, and both the first contact surface of the first engagement member and the third contact surface of the second engagement member are perpendicular to the planar first flat face of the elongated body.

9. The tool according to claim 8, wherein the first engagement member and the second engagement member are located on one side of a dividing plane located between and separating the planar first flat face and the opposed planar second flat face, and the handle and one of the divergent members is located on the other side of the dividing plane, thereby leaving a straight section of the elongated body available for sliding contact with the large headed stake, whereby the tool can be accelerated along a straight line while sliding against the large headed stake so that a significant impact may be generated upon contact of the first engagement member and the second engagement member with the large headed stake.
